(19) United States
(12) Patent Application Publication
(10) Pub. No.: US 2022/0245721 A1
(43) Pub. Date: Aug. 4, 2022

(54) MACHINE LEARNING BASED AUTOMATED SAVINGS GOALS

(71) Applicant: Intuit Inc., Mountain View, CA (US)

(72) Inventor: Yair Horesh, Kfar-Saba (IL)

(73) Assignee: Intuit Inc., Mountain View, CA (US)

(21) Appl. No.: 17/166,203

(22) Filed: Feb. 3, 2021

(51) Int. Cl. G06Q 40/02; G06N 20/00; G06Q 30/02

(52) U.S. Cl. CPC G06Q 40/02; G06Q 30/0204; G06N 20/00

(57) ABSTRACT

Systems and methods for recommending and automating user savings goals within a single banking account are disclosed. An example method is performed by an electronic device coupled to a machine learning model and includes training the machine learning model based at least in part on historical user data, receiving attributes of a first user, generating, using the trained machine learning model, one or more recommended savings goals for the first user based at least in part on the attributes of the first user, receiving selection of one or more of the recommended savings goals, determining, using a trained classification model, a recommended amount for the first user to periodically save, the recommended amount determined based at least in part on the attributes of the first user, and periodically allocating savings to each of the one or more selected savings goals based at least in part on the recommended amount.

### TECHNICAL FIELD

This disclosure relates generally to methods for using machine learning to recommend personal savings goals and periodic savings amounts, and automatically managing and allocating savings to those goals within a single banking account.

### DESCRIPTION OF RELATED ART

People often desire to save money towards goals, whether those goals are for the purchasing of gifts, travel, or entertainment, and so on. However, it may be difficult for people to create, manage, and monitor such savings, and to plan such savings goals in detail. Conventional savings systems may use one or more separate accounts for collecting and managing such savings, which may create additional complexity and risks of overdraft and additional banking fees.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for recommending and automating user savings goals within a single banking account are disclosed. An example method is performed by an electronic device coupled to a machine learning model and includes training the machine learning model based at least in part on historical user data, receiving attributes of a first user, generating, using the trained machine learning model, one or more recommended savings goals for the first user based at least in part on the attributes of the first user, receiving selection of one or more of the recommended savings goals, determining, using a trained classification model, a recommended amount for the first user to periodically save, the recommended amount determined based at least in part on the attributes of the first user, and periodically allocating savings to each of the one or more selected savings goals based at least in part on the recommended amount.

In some aspects, the historical user data maps historical user transaction categories and historical user attributes to corresponding previously selected savings goals of historical users. In some aspects, each savings goal includes at least a savings amount and a time for saving the savings amount. In some aspects each savings goal may additionally include a savings priority. In some aspects, each savings amount may include a range of acceptable amounts. In some aspects, a savings goal may be associated with one or more child savings goals or one or more parent savings goals.

In some aspects, the trained classification model maps savings amounts and attributes of users to corresponding savings goal failure indicators. Each savings goal failure indicator may indicate whether or not a corresponding savings goal is predicted to be unsuccessful. The savings goal failure indicators may include a binary value indicating whether or not the corresponding savings goal is predicted to be unsuccessful and a confidence value in the prediction. In some aspects, the recommended amount for the first user to periodically save may be a highest savings amount predicted by the trained classification model to result in a successful savings goal. In some aspects, this highest savings amount may be an amount corresponding to a savings goal failure indicator indicating success with at least a threshold confidence value.

In some aspects, periodically allocating savings may include, once per specified time period, selecting an amount to be allocated among the one or more selected savings goals, selecting a corresponding portion of the amount to be allocated to each respective savings goal of the one or more selected savings goals, and assigning the corresponding portion to each respective savings goal of the one or more selected savings goals. In some aspects selecting the corresponding portion of the amount to be allocated to each respective savings goal may include determining an ideal allocation amount for each savings goal, determining a prioritized allocation amount for each ideal allocation amount based on a priority of the respective savings goal, determining a savings goal score for each respective savings goal based at least in part on the prioritized allocation amount and a time elapsed from a most recent assignment of savings to the respective savings goal, and selecting the corresponding portion of the amount to be allocated to each respective savings goal based at least in part on the savings goal scores for each respective savings goal normalized by the amount to be allocated.

In some aspects, the method may further include, in response to completing a savings goal, updating training data for the machine learning model based at least in part on the attributes of the first user.

In some aspects, the method may further include determining that an unallocated amount in the single banking account is less than an new expense of the first user, and breaking one or more savings goals by proportionately reallocating savings away from the one or more savings goals based at least in part on a difference between the new expense and the unallocated amount in the single banking account. In some aspects, the method may further include updating training data for the classification model based at least in part on the broken one or more savings goals.

Another innovative aspect of the subject matter described in this disclosure can be implemented in a system for recommending and automating savings goals within a single banking account. An example system may be associated with a machine learning model and include or more processors, and a memory storing instructions for execution by the one or more processors. Execution of the instructions causes the system to perform operations including training the machine learning model based at least in part on historical user data, receiving attributes of a first user, generating, using the trained machine learning model, one or more recommended savings goals for the first user based at least in part on the attributes of the first user, receiving selection of one or more of the recommended savings goals, determining, using a trained classification model, a recommended amount for the first user to periodically save, the recommended amount determined based at least in part on the attributes of the first user, and periodically allocating savings to each of the one or more selected savings goals based at least in part on the recommended amount.

In some aspects, the historical user data maps historical user transaction categories and historical user attributes to corresponding previously selected savings goals of historical users. In some aspects, each savings goal includes at least a savings amount and a time for saving the savings amount. In some aspects each savings goal may additionally include a savings priority. In some aspects, each savings amount may include a range of acceptable amounts. In some aspects, a savings goal may be associated with one or more child savings goals or one or more parent savings goals.

In some aspects, the trained classification model maps savings amounts and attributes of users to corresponding savings goal failure indicators. Each savings goal failure indicator may indicate whether or not a corresponding savings goal is predicted to be unsuccessful. The savings goal failure indicators may include a binary value indicating whether or not the corresponding savings goal is predicted to be unsuccessful and a confidence value in the prediction. In some aspects, the recommended amount for the first user to periodically save may be a highest savings amount predicted by the trained classification model to result in a successful savings goal. In some aspects, this highest savings amount may be an amount corresponding to a savings goal failure indicator indicating success with at least a threshold confidence value.

In some aspects, periodically allocating savings may include, once per specified time period, selecting an amount to be allocated among the one or more selected savings goals, selecting a corresponding portion of the amount to be allocated to each respective savings goal of the one or more selected savings goals, and assigning the corresponding portion to each respective savings goal of the one or more selected savings goals. In some aspects selecting the corresponding portion of the amount to be allocated to each respective savings goal may include determining an ideal allocation amount for each savings goal, determining a prioritized allocation amount for each ideal allocation amount based on a priority of the respective savings goal, determining a savings goal score for each respective savings goal based at least in part on the prioritized allocation amount and a time elapsed from a most recent assignment of savings to the respective savings goal, and selecting the corresponding portion of the amount to be allocated to each respective savings goal based at least in part on the savings goal scores for each respective savings goal normalized by the amount to be allocated.

In some aspects, the operations may further include, in response to completing a savings goal, updating training data for the machine learning model based at least in part on the attributes of the first user.

In some aspects, the operations may further include determining that an unallocated amount in the single banking account is less than an new expense of the first user, and breaking one or more savings goals by proportionately reallocating savings away from the one or more savings goals based at least in part on a difference between the new expense and the unallocated amount in the single banking account. In some aspects, the operations may further include updating training data for the classification model based at least in part on the broken one or more savings goals.

Another innovative aspect of the subject matter described in this disclosure can be implemented in a system for recommending and automating savings goals within a single banking account. An example system may be associated with a machine learning model and include or more processors, and a memory storing instructions for execution by the one or more processors. Execution of the instructions causes the system to perform operations including training the machine learning model based at least in part on historical user data, receiving attributes of a first user, generating, using the trained machine learning model, one or more recommended savings goals for the first user based at least in part on the attributes of the first user, receiving selection of one or more of the recommended savings goals, determining, using a trained classification model, a recommended amount for the first user to periodically save, the recommended amount being a highest savings amount predicted by the trained classification model to result in a successful savings goal, and periodically allocating savings to each of the one or more selected savings goals based at least in part on the recommended amount.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a savings recommendation and allocation system, according to some implementations.

FIG. 2 shows a high-level overview of an example process flow that may be employed by the savings recommendation and allocation system of FIG. 1.

FIG. 3 shows an illustrative flow chart depicting an example operation for recommending and automating savings goals within a single banking account, according to some implementations.

FIG. 4 shows an illustrative flow chart depicting an example operation for allocating savings to savings goals within a single banking account, according to some implementations.

FIG. 5 shows an illustrative flow chart depicting an example operation for safely breaking one or more savings goals, according to some implementations.

Like numbers reference like elements throughout the drawings and specification.

### DETAILED DESCRIPTION

Implementations of the subject matter described in this disclosure may be used to recommend and manage multiple savings goals in a single banking account using one or more machine learning models and one or more classification models. For example, the one or more machine learning models may be trained based on historical user data to recommend savings goals for users based on corresponding attributes of the users. Upon receiving selection of one or more of the recommended savings goals, the example implementations may determine recommended savings amounts for the selected savings goals, using the one or more classification models. The recommended savings amounts may be determined by the classification models based at least in part on the attributes of the users. Savings may then be periodically allocated to the savings goals based at least in part on the recommended amounts. For example, the machine learning models may be trained based on historical user data mapping transaction categories and user attributes of historical users to corresponding previously savings goals selected by the historical users. The classification model may be trained to map savings amounts and attributes of users to corresponding savings goal failure indicators. Such savings goal failure indicators may indicate whether or not a corresponding savings goal was unsuccessful. The recommended amount may be selected by the classification model to be a highest savings amount predicted to result in a successful savings goal. Such savings goals may include at least a savings amount and a target date for achieving the savings amount. Optionally, the savings goals may also include a priority for the goal, a range of acceptable amounts to save, one or more parent or child goals, and so on. These, and other aspects of the example implementations are discussed further below.

Various implementations of the subject matter disclosed herein provide one or more technical solutions to the technical problem of determining savings goals and automating allocation of savings to those goals while avoiding the complexity of multiple accounts and avoiding the risks of overdraft. Unlike conventional systems for managing user savings goals, which may use multiple accounts, creating complexity and risking overdraft and banking fees, the example implementations provide tools for recommending and automating savings goals for users using a single banking account. Using machine learning for recommending savings goals to a user based on historical user data may be particularly effective for selecting savings goals tailored to a user. Further, allowing a classifier to recommend how much a user can afford to save, and using a savings manager to automate allocation of savings to the goals may allow a user to achieve selected savings goals efficiently and safely, without requiring the user to micromanage savings. More specifically, various aspects of the present disclosure provide a unique computing solution to a unique computing problem that did not exist prior to electronic or online financial management systems that can maintain and coordinate historical data from large numbers of historical users in order to recommend appropriate savings goals to users, and to automate allocation of savings to selected goals. As such, implementations of the subject matter disclosed herein are not an abstract idea such as organizing human activity or a mental process that can be performed in the human mind.

Moreover, various aspects of the present disclosure effect an improvement in the technical field of safely and efficiently recommending and achieving recommended savings goals. Training the machine learning model and classification model and using the trained models cannot be performed in the human mind, much less using pen and paper. In addition, implementations of the subject matter disclosed herein do far more than merely create contractual relationships, hedge risks, mitigate settlement risks, and the like, and therefore cannot be considered a fundamental economic practice.

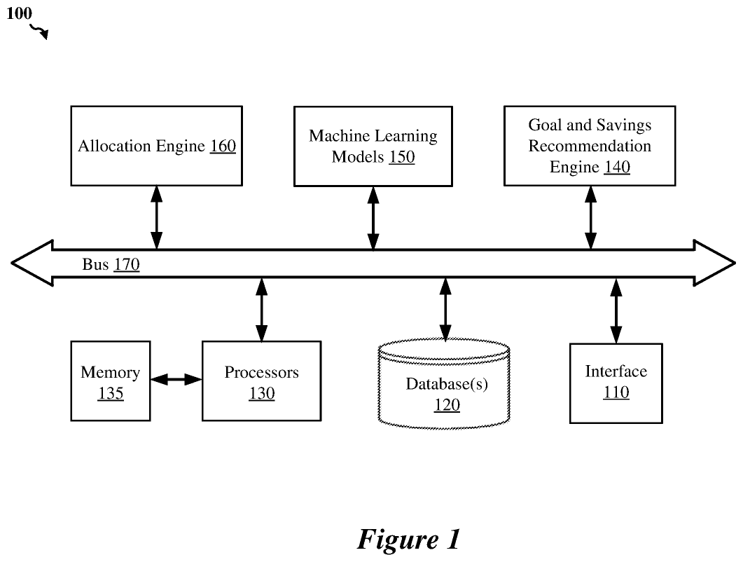

FIG. 1 shows a savings recommendation and allocation system 100, according to some implementations. The savings recommendation and allocation system 100 is shown to include an input/output (I/O) interface 110, a database 120, one or more data processors 130, a memory 135 coupled to the data processors 130, a goal and savings recommendation engine 140, one or more machine learning models 150, and an allocation engine 160. In some implementations, the various components of the savings recommendation and allocation system 100 may be interconnected by at least a data bus 170, as depicted in the example of FIG. 1. In other implementations, the various components of the savings recommendation and allocation system 100 may be interconnected using other suitable signal routing resources.

The interface 110 may include a screen, an input device, and other suitable elements that allow a user to provide information to the savings recommendation and allocation system 100 and/or to retrieve information from the savings recommendation and allocation system 100. Example information that can be provided to the savings recommendation and allocation system 100 may include configuration information for the savings recommendation and allocation system 100, such as training data for the machine learning models 150, historical user data for historical users of the savings recommendation and allocation system 100, user demographic data, such as industry, location, and so on for the historical users, historical savings goal success metrics for previous savings goals of the historical users, one or more rules or algorithms for allocating savings for the allocation engine 160, current banking account balance information, or the like. Example information that can be retrieved from the savings recommendation and allocation system 100 may include goal success announcements, demographic and other information for updating training data, and the like.

The database 120, which may represent any suitable number of databases, may store any suitable information pertaining to users, such as current financial, demographic, industry, or other information, in addition to training data for the machine learning models 150, configuration information for the savings recommendation and allocation system 100, historical user data for historical users of the savings recommendation and allocation system 100, one or more rules or algorithms for training the machine learning models 150 or the classification models of the goal and savings recommendation engine 140, or the like. For example, the information may include information for a number of historical users analyzed by the savings recommendation and allocation system 100 (such as phone numbers, email addresses, physical mailing address, billing information, and so on), and so on. In some implementations, the database 120 may be a relational database capable of presenting the information as data sets to a user in tabular form and capable of manipulating the data sets using relational operators. In some aspects, the database 120 may use Structured Query Language (SQL) for querying and maintaining the database 120.

The data processors 130, which may be used for general data processing operations (such as manipulating the data sets stored in the database 120), may be one or more suitable processors capable of executing scripts or instructions of one or more software programs stored in the savings recommendation and allocation system 100 (such as within the memory 135). The data processors 130 may be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the data processors 130 may be implemented as a combination of computing devices (such as a combination of a DSP and a microprocessor, a plurality of microprocessors, one or more microprocessors in conjunction with a DSP core, or any other such configuration).

The memory 135, which may be any suitable persistent memory (such as non-volatile memory or non-transitory memory) may store any number of software programs, executable instructions, machine code, algorithms, and the like that can be executed by the data processors 130 to perform one or more corresponding operations or functions. In some implementations, hardwired circuitry may be used in place of, or in combination with, software instructions to implement aspects of the disclosure. As such, implementations of the subject matter disclosed herein are not limited to any specific combination of hardware circuitry and/or software.

The goal and savings recommendation engine 140 may train the machine learning models 150 to recommend savings goals based on user attributes. In some aspects, the goal and savings recommendation engine 140 may incorporate a user interface (UI) or a user experience (UX) for recommending savings goals and amounts to users of the savings recommendation and allocation system 100. The goal and savings recommendation engine 140 may train the machine learning models 150 using training data based on historical user data of historical users of the savings recommendation and allocation system 100. Such historical user data may map historical user transaction categories and historical user attributes to corresponding previously selected savings goals of the historical users. The historical user attributes may include demographic and financial data of the historical users, such as location, age, marital status, income, expenses, assets, and so on. The training data may, for example be stored in the database 120. After training the machine learning models 150, the goal and savings recommendation engine 140 may use the trained machine learning models 150 to recommend one or more savings goals to a user of the savings recommendation and allocation system 100 based on the user's attributes, such as the user's demographic and financial data. After providing the recommended one or more savings goals to the user, the goal and savings recommendation engine 140 may receive selection of at least one of the recommended one or more savings goals.

The goal and savings recommendation engine 140 may also include one or more classification models. The one or more classification models may be trained based on historical user attributes such as profession, demographic information, income, asset, and expenses data, historical user savings as a proportion of income, and so on. The one or more trained classification models may map, based on received user attributes, recommended savings amounts for a user to a binary field indicating whether or not saving at the recommended amount is projected to succeed or fail for the user. In some aspects, the recommended savings amount may be a fixed amount for periodic allocation, a proportion of the user's periodic income, and so on. Saving at a particular savings amount “fails” when money must be removed from savings toward one or more goals, for example to free money for another purchase or to prevent overdraft. This binary field may be referred to as a savings goal failure indicator, indicating success or failure for savings at a specified savings level with a corresponding confidence value, such as a percentage confidence value. In some aspects, the goal and savings recommendation engine 140 may recommend an amount for a user to save which is the largest savings amount predicted by the trained classification models to have a savings goal failure indicator indicating success at a specified confidence value, such as a 90% or a 95% confidence value. In some aspects, the user may accept the recommended savings amount or select another amount to be periodically allocated to the user's savings goals.

The machine learning models 150 may include any number of machine learning models that can be used to recommend savings goals to users of the savings recommendation and allocation system 100. A machine learning model can take the form of an extensible data structure that can be used to represent sets of words or phrases and/or can be used to represent sets of attributes or features. The machine learning models may be seeded with historical data indicating relationships between field values and values of dependent fields for one or more historical users. In some implementations, the machine learning models 150 may include deep neural networks (DNNs), which may have any suitable architecture, such as a feedforward architecture or a recurrent architecture. The machine learning models 150 may predict savings goals for users of the savings recommendation and allocation system 100, for example based on the users' attributes, such as financial and demographic attributes. The machine learning models 150 may be trained based on historical user data such as historical users' financial and demographic data and corresponding selected savings goals of the historical users, as discussed further below.

The allocation engine 160 may be used to periodically allocate a user's savings to the user's savings goals. For example, the allocation engine 160 may periodically allocate the recommended savings amount to the user's savings goals, or another amount selected by the user. As discussed in more detail below, this periodic allocation may be based on the respective amounts to be saved and the target dates for each savings goal. In some aspects, the allocation may additionally be based on a priority of one or more of the savings goals. The allocation may also be based on a time elapsed since savings was added to each of the user's savings goals.

The particular architecture of the savings recommendation and allocation system 100 shown in FIG. 1 is but one example of a variety of different architectures within which aspects of the present disclosure may be implemented. For example, in other implementations, the savings recommendation and allocation system 100 may not include goal and savings recommendation engine 140, the functions of which may be implemented by the processors 130 executing corresponding instructions or scripts stored in the memory 135. In some other implementations, the functions of the machine learning models 150 may be performed by the processors 130 executing corresponding instructions or scripts stored in the memory 135. Similarly, the functions of the allocation engine 160 may be performed by the processors 130 executing corresponding instructions or scripts stored in the memory 135.

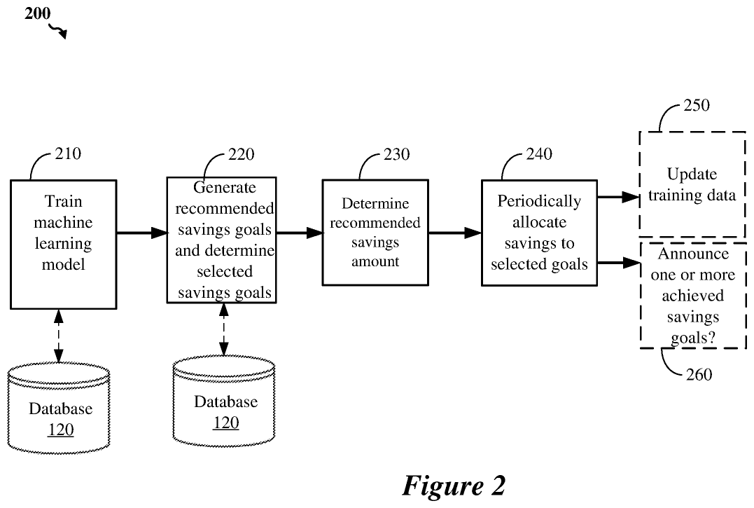

FIG. 2 shows a high-level overview of an example process flow 200 that may be employed by the savings recommendation and allocation system 100 of FIG. 1. In block 210, the machine learning models 150 are trained by the goal and savings recommendation engine 140. For example, the machine learning models may be trained based on training data retrieved from the databased 120, received via one or more network interfaces coupled to the savings recommendation and allocation system 100, or retrieved from another memory coupled to the savings recommendation and allocation system 100. In block 220, the goal and savings recommendation engine 140 may use the trained machine learning models 150 to generate one or more recommended savings goals for a user of the savings recommendation and allocation engine 100 and determine one or more selected savings goals for the user. For example, the trained machine learning models may generate one or more recommended savings goals based on attributes of a user, such as demographic or financial attributes. Such attributes may be retrieved from the databased 120, received via one or more network interfaces coupled to the savings recommendation and allocation system 100, or retrieved from another memory coupled to the savings recommendation and allocation system 100. A selection of one or more of the recommended savings goals may then be received from the user. In block 230, the goal and savings recommendation engine 140 may determine a recommended savings amount for the user to periodically allocate to the user's selected savings goals. For example, recommended savings amount may be determined using a trained classification model of the goal and savings recommendation engine 140, as discussed above. In block 240, the allocation engine 160 may periodically allocate the user's savings to the selected savings goals. For example, as discussed further below, the allocation engine 160 may allocate the user's savings based at least in part on one or more of the respective amounts to be saved and the target dates for each savings goal, a priority of one or more of the savings goals, a time elapsed since savings was added to each of the user's savings goals, and so on. In block 250, the training data for the machine learning models 150 may optionally be updated, for example based on one or more failed savings goals, based on the savings goals selected by the user and the attributes of the user, and so on. In block 260, the savings recommendation and allocation system 100 may optionally announce one or more achieved savings goals. For example, the user may be prompted to announce one or more achieved savings goals, for example via one or more social media accounts of the user.

As discussed above, users often desire to budget their income and savings for desired purposes, or goals. For example, a user may wish to save towards a desired purchase or towards a specific category of purchase, such as entertainment or dining. However, while users often desire to budget their savings to desired goals, users may have difficulty determining how much they should save for each goal, determining appropriate timescales and priorities for such goals, and so on. Further, a user may have a plurality of such goals, and fairly allocating savings to each goal may be difficult for a user to manage. For example, it may be difficult for a user to decide which goal to allocate savings to, and how to ensure goals are met while also avoiding overdraft. Further, a user may have difficulty determining how much they can afford to save towards their goals, for example how much the user may safely save on a periodic basis, such as a weekly, biweekly, or monthly basis. Finally, conventional approaches for user savings goals may require the use of one or more additional banking accounts, which may increase the risk of overdraft of additional banking fees, as well as increasing complexity for the user.

Accordingly, the example implementations may assist a user by recommending savings goals, using one or more trained machine learning models and assist a user by determining and recommending how much the user can afford to periodically save. Further, after a user has selected savings goals, based on the recommended savings goals, and after a savings amount has been determined, for example based on the recommended savings amount, the example implementations may periodically allocate the user's savings to their selected savings goals. Allocating the user's savings to the savings goals may not require moving money between accounts. Instead, the example implementations require only a single banking account, and allocates the user's savings to a number of virtual sub-accounts, each corresponding to a selected savings goal. Using a single banking account may reduce likelihood of overdraft and avoid bank involvement with routing the savings between accounts. Further, the example implementations may enable fair and efficient allocation of the user's savings to the user's selected savings goals, without requiring the user to micromanage their savings.

As discussed herein, a “goal” may include multiple pieces of information. A goal includes at minimum, a name, a time for completion, and an amount to save. The name of a goal may be a specific item for purchase, a descriptive name selected by a user, a financial transaction category, or any other suitable identifier for the goal. A time for completion of a goal may be a specific date, a time period for completing the goal such as a number of days or weeks, or any other suitable timeframe for completing the goal. The amount to save may be a flat amount to save, a range of acceptable amounts to save, a target amount per time period to save, such as an amount per week, and so on. The target amount per time period may be expressed as a fixed amount, a ratio such as a percentage of income per time period, or the like. A goal may also include one or more optional pieces of information. For example, a goal may include a priority, such as a high, medium, or low priority. In some aspects, a goal's priority may be expressed as a number, such as 1 for a low priority goal, 2 for a medium priority goal, and three for a high priority goal. Alternatively, lower numbers may express higher priorities, such as 1 for a high priority goal, and 3 for a low priority goal. Other forms of expressing priority, and other numbers of different priority levels may also be used for representing priority of a goal. Further, goals may have hierarchy, that is, goals may have sub-goals, or be sub-goals of a parent goal. Sub-goals may also be called child goals. For example, a user may have a goal of saving enough to attend a concert once per month, and such a goal may be considered a child goal of an overarching parent goal representing savings for entertainment in general. Parent goals may optionally include a target amount to save for a sum of their child goals, or a range of acceptable target amounts to save for the sum of their child goals, or similar.

As discussed above, while users often desire to budget their savings for desired goals, it may be more difficult for a user to determine these goals with specificity in light of the user's personal and financial circumstances. For example, a user may desire to save for a particular goal, such as a meal at a restaurant, or a new suit, but have difficulty determining how long saving toward such a goal may take. Further, while a user may periodically have a meal at a restaurant or another expense, the user may find it difficult to plan savings for such expenses in advance, which may potentially lead to shortfalls, for example in the days prior to a next paycheck. In order to alleviate such problems, and to recommend appropriate savings goals to users more effectively, the machine learning models 150 may be trained using training data based on historical users of the savings recommendation and allocation system 100. For example, the training data may map historical user attributes and financial transaction categories of historical transactions of the historical users to corresponding savings goals selected by those historical users. Such user attributes may include demographic and financial attributes of the historical users, such as location, occupation, income, marital status, expenses, assets, and may also include statistics derived from the user attributes, such as mean and standard deviation of income or expenses, or savings as a proportion of income, or a ratio of income to expenses, and so on.

The savings recommendation and allocation system 100 may then generate one or more recommended savings goals for a first user using the trained machine learning models 150. The trained machine learning models 150 may generate these recommended savings goals based on the attributes of the first user, such as demographic and financial attributes of the first user. For example, the recommended goals may depend on the first user's transaction history, such that a user with a large number of transactions and restaurants and taverns may be recommended differing savings goals than a user who instead has a large number of charitable donations in their transaction history. The first user may then select one or more of the recommended savings goals. As discussed above, the goal and savings recommendation engine 140 may include a UI, UX, or similar which may present the recommended savings goals to the first user, and allow the user to view these recommended savings goals and to select one or more savings goals (or select their own savings goals). The UX may also allow the first user to view the current status of their selected savings goals, to edit their selected savings goals, to estimate completion dates for their selected savings goals, and so on. Further, once a savings goal is achieved, the UX may allow the first user to withdraw the savings for the completed goal, to freeze the savings for the completed goal, to edit the goal, or similar. Finally, the UX may also include gamification or social functions, such as enabling the first user to share a completed savings goal with one or more social networks, to earn achievements for completed savings goals, and similar.

In addition to generating the recommended savings goals, and receiving the first user's selection of one or more recommended savings goals, the goal and savings recommendation engine 140 may determine a recommended amount for the first user to periodically save toward their selected savings goals For example, as discussed above, one or more classification models of the savings recommendation and allocation system 100 may be trained using training data based on historical user attributes such as demographic and financial attributes of historical users of the savings recommendation and allocation system 100. As discussed above, the classification models may be trained to map these user attributes and a periodic savings amount to a binary savings goal failure indicator, indicating success or failure for savings at the periodic savings amount. For example, the periodic savings amount may be expressed as a fixed amount, or as a fraction or percentage of user income. The trained classification models may then determine a recommended amount for the first user to periodically allocate to their selected savings goals, based on attributes of the first user, such as demographic and financial attributes of the first user. The recommended amount for the first user to save may be the largest savings amount predicted by the trained classification models to have a savings goal failure indicator indicating success at a specified confidence value, such as a 90% or a 95% confidence value. The first user may then accept, edit, or replace the recommended savings amount. In some aspects, if the first user does not accept, edit, or replace the recommended savings amount, the goal and savings recommendation engine 140 may select a default amount to save. For example, the default amount may be a specified percentage of the first user's periodic income. In one example, the default amount may be an integer number of dollars just below 1% of the first user's periodic income, although in other aspects the default amount may have other non-integer amounts, and other percentages of the first user's periodic income.

After determining the selected savings goals of the first user, based on the recommended savings goals, and determining the periodic amount the first user wishes to save towards those savings goals, based on the recommended amount for the first user to save, the allocation engine 160 may periodically allocate savings to the first user's selected savings goals. For example, the allocation engine 160 may periodically allocate the amount selected by the first user, which may be the recommended amount, or another amount edited or substituted by the first user, or the allocation engine 160 may periodically allocate the default amount. The allocation engine may apply any suitable policy for allocating the savings to the selected goals.

In some aspects, the allocation engine 10 may apply the following policy for periodically allocating the savings to the selected goals. For example, each goal Gi, for i between 1 and N, may have an amount MLGi left to the target amount for the goal, a time TLDi remaining before the target date, where TLDi may be measured in days or another suitable timescale, a time elapsed TFRi since the most recent allocation of savings to goal I, and optionally a priority PRi of the goal. The ideal sum IAGi for each goal may be determined as IAGi=MLGi/TLDi. If priority is applied, then this ideal sum may be weighted to determine the priority weighted ideal sum IAG_PRi=IAGi*PRi. A score Si for each goal may then be determined as Si=IAG_PRi*(TFRi+K), where K may be a small constant such as 3, 4, 5, or another small value. If no priority has been assigned to the goals, then the score Si=IAGi*(TFRi+K). The scores Si may then be normalized by the periodic amount to save. That is, the scores are normalized such that the scores for all of the goals sum to the amount to be periodically allocated. The normalized scores may then be rounded down to a nearest whole value, such as being rounded down to a nearest cent. If there is a remainder, it may be assigned to one of the goals, such as the goal with the lowest allocation, or to a goal with the highest priority.

In some aspects, while the first user's selected goals are in process, the first user may have an expense which is greater than an amount of available money in the user's banking account. That is, while the banking account includes enough money to cover the expense, insufficient resources remain after accounting for the money allocated to the first user's selected goals. In such circumstances, the goal and savings recommendation and allocation system 100 may deallocate from the selected goals in order to free resources to meet the expense. In some aspects, the savings recommendation and allocation system 100 may deallocate resources from all goals as a proportion of the amount saved in order to meet the expense. In some other aspects, resources may initially be deallocated from lower priority goals, before deallocating from higher priority goals. Alternatively, resources may initially be deallocated from goals with a longer remaining time until their target date. In response to such deallocation, UX of the goal and savings recommendation engine 140 may present a recommendation to the first user to lower the periodic amount to save.

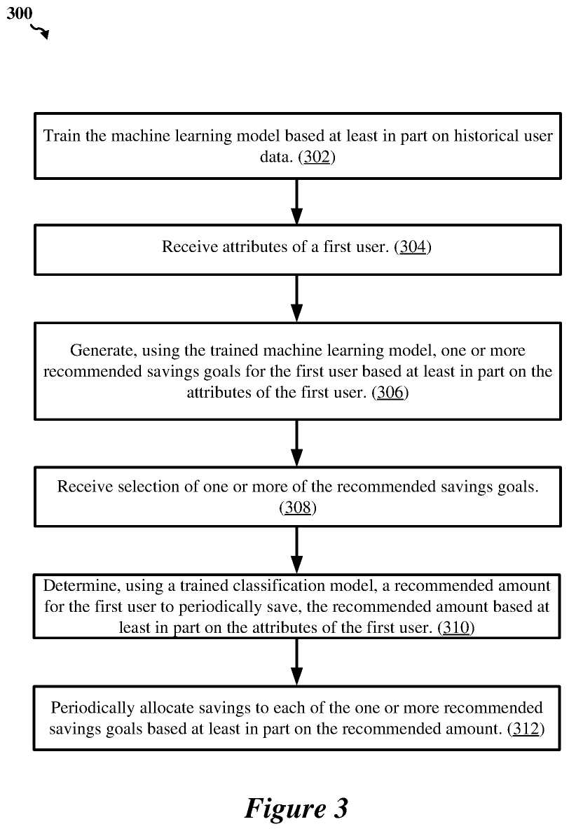

FIG. 3 shows an illustrative flow chart depicting an example operation 300 for recommending and automating savings goals within a single banking account, according to some implementations. The example operation 300 may be performed by one or more processors of a computing device, and in some implementations, the example operation 300 may be performed using the savings recommendation and allocation system 100 of FIG. 1. It is to be understood that the example operation 300 may be performed by any suitable systems, computers, or servers.

At block 302, the savings recommendation and allocation system 100 trains a machine learning model associated with the savings recommendation and allocation system 100 based at least in part on historical user data. At block 304, the savings recommendation and allocation system 100 receives attributes of a first user. At block 306, the savings recommendation and allocation system 100 generates, using the trained machine learning model, one or more recommended savings goals for the first user based at least in part on the attributes of the first user. At block 308, the savings recommendation and allocation system 100 receives selection of one or more of the recommended savings goals. At block 310, the savings recommendation and allocation system 100 determines, using a trained classification model, a recommended amount for the first user to periodically save, where the recommended amount is based at least in part on the attributes of the first user. At block 312 the savings recommendation and allocation system 100 periodically allocates savings to each of the one or more recommended savings goals based at least in part on the recommended amount.

In some aspects, the historical user data maps historical user transaction categories and historical user attributes to corresponding previously selected savings goals of historical users of the savings recommendation and allocation system 100. In some aspects, each savings goal includes at least a savings amount and a time for saving the savings amount. In some aspects each savings goal may additionally include a savings priority. In some aspects, each savings amount may include a range of acceptable amounts. In some aspects, a savings goal may be associated with one or more child savings goals or one or more parent savings goals.

In some aspects, the trained classification model maps savings amounts and attributes of users to corresponding savings goal failure indicators. Each savings goal failure indicator may indicate whether or not a corresponding savings goal is predicted to be unsuccessful. The savings goal failure indicators may include a binary value indicating whether or not the corresponding savings goal is predicted to be unsuccessful and a confidence value in the prediction. In some aspects, the recommended amount for the first user to periodically save in block 310 may be a highest savings amount predicted by the trained classification model to result in a successful savings goal. In some aspects, this highest savings amount may be an amount corresponding to a savings goal failure indicator indicating success with at least a threshold confidence value.

In some aspects, periodically allocating savings in block 312 may include, once per specified time period, selecting an amount to be allocated among the one or more selected savings goals, selecting a corresponding portion of the amount to be allocated to each respective savings goal of the one or more selected savings goals, and assigning the corresponding portion to each respective savings goal of the one or more selected savings goals. In some aspects selecting the corresponding portion of the amount to be allocated to each respective savings goal may include determining an ideal allocation amount for each savings goal, determining a prioritized allocation amount for each ideal allocation amount based on a priority of the respective savings goal, determining a savings goal score for each respective savings goal based at least in part on the prioritized allocation amount and a time elapsed from a most recent assignment of savings to the respective savings goal, and selecting the corresponding portion of the amount to be allocated to each respective savings goal based at least in part on the savings goal scores for each respective savings goal normalized by the amount to be allocated.

In some aspects, the operation 300 may further include, in response to completing a savings goal, updating training data for the machine learning model based at least in part on the attributes of the first user.

In some aspects, the operation 300 may further include determining that an unallocated amount in the single banking account is less than an new expense of the first user, and breaking one or more savings goals by proportionately reallocating savings away from the one or more savings goals based at least in part on a difference between the new expense and the unallocated amount in the single banking account. In some aspects, the operation 300 may further include updating training data for the classification model based at least in part on the broken one or more savings goals.

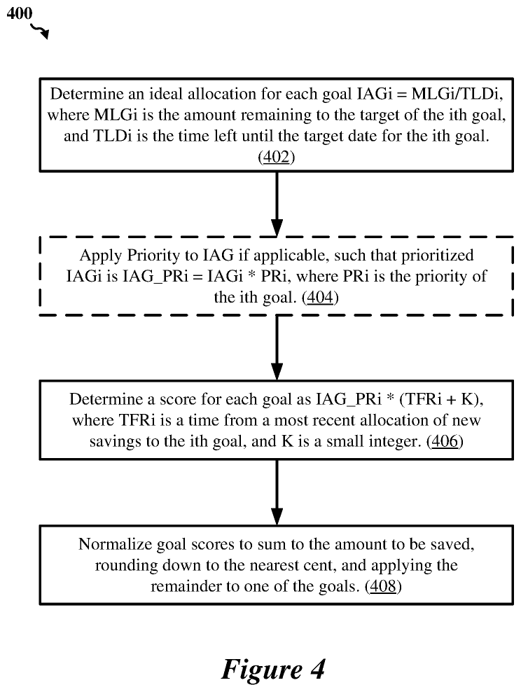

FIG. 4 shows an illustrative flow chart depicting an example operation 400 for allocating savings to savings goals within a single banking account, according to some implementations. The example operation 400 may be performed by one or more processors of a computing device, and in some implementations, the example operation 400 may be performed using the savings recommendation and allocation system 100 of FIG. 1, and more particularly may be performed using the allocation engine 160 of the savings recommendation and allocation system 100. It is to be understood that the example operation 400 may be performed by any suitable systems, computers, or servers. The operation 400 may represent an example of a suitable policy for allocating the savings to the selected goals, as discussed above.

In block 402, the allocation engine 160 may determine an ideal allocation for each goal to be IAGi=MLGi/TLDi, where MLGi is the amount remaining to the target of the ith goal, and TLDi is the time left until the target date for the ith goal. At block 404, the allocation engine 160 may apply a priority to the ideal allocation for each goal and determine a prioritized IAGi as IAG_PRi=IAGi*PRi, where PRi is the priority of the ith goal. At block 406, the allocation engine 160 may determine a score Si for each goal as Si=IAG_PRi*(TFRi+K), where TFRi is a time from a most recent allocation of new savings to the ith goal, and K is a small integer. At block 408, the allocation engine may normalize the goal scores to sum to the amount to be saved, rounding down to the nearest cent, and applying any remainder to one of the goals.

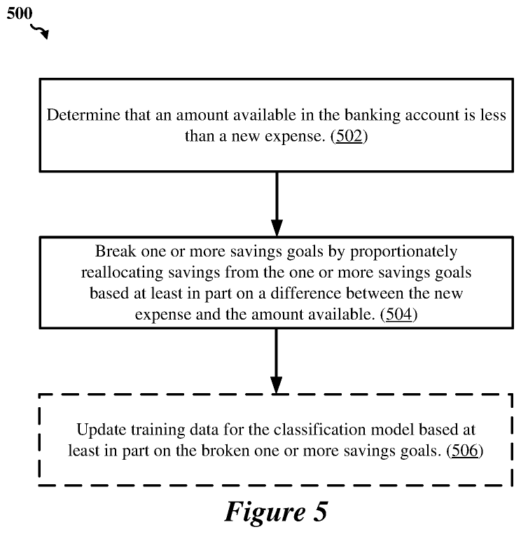

FIG. 5 shows an illustrative flow chart depicting an example operation 500 for safely breaking one or more savings goals, according to some implementations. The example operation 500 may be performed by one or more processors of a computing device, and in some implementations, the example operation 500 may be performed using the savings recommendation and allocation system 100 of FIG. 1, and more particularly may be performed using the allocation engine 160 of the savings recommendation and allocation system 100. It is to be understood that the example operation 500 may be performed by any suitable systems, computers, or servers.

At block 502, the allocation engine 160 may determine than an unallocated amount in the single banking account is less than a new expense. At block 504, the allocation engine 160 may break one or more savings goals by proportionately reallocating savings away from the one or more savings goals based at least in part on a difference between the new expense and the unallocated amount in the single banking account. At block 505, the allocation engine 160 may optionally update training data for the classification model based at least in part on the broken one or more savings goals.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method of recommending and automating savings goals within a single banking account, the method performed by an electronic device coupled to a machine learning model and comprising:
training the machine learning model based at least in part on historical user data;
receiving attributes of a first user;
generating, using the trained machine learning model, one or more recommended savings goals for the first user based at least in part on the attributes of the first user;
receiving selection of one or more of the recommended savings goals;
determining, using a trained classification model, a recommended amount for the first user to periodically save, the recommended amount determined based at least in part on the attributes of the first user; and
periodically allocating savings to each of the one or more selected savings goals based at least in part on the recommended amount.

2. The method of claim 1, wherein the historical user data maps historical user transaction categories and historical user attributes to corresponding previously selected savings goals of historical users.

3. The method of claim 1, wherein the trained classification model maps savings amounts and attributes of users to corresponding savings goal failure indicators.

4. The method of claim 3, wherein each savings goal failure indicator indicates whether or not a corresponding savings goal is predicted to be unsuccessful.

5. The method of claim 3, wherein the recommended amount is a highest savings amount predicted by the trained classification model to result in a successful savings goal.

6. The method of claim 1, wherein each savings goal comprises at least a savings amount and a target time for saving the savings amount.

7. The method of claim 6, wherein each savings goal further comprises a savings priority.

8. The method of claim 6, wherein the savings amount comprises a range of acceptable amounts.

9. The method of claim 6, wherein a savings goal may be associated with one or more child savings goals or one or more parent savings goals.

10. The method of claim 1, wherein periodically allocating savings to each of the one or more selected savings goals comprises, once per specified time period:
selecting an amount to be allocated among the one or more selected savings goals;
selecting a corresponding portion of the amount to be allocated to each respective savings goal of the one or more selected savings goals; and
assigning the corresponding portion to each respective savings goal of the one or more selected savings goals.

11. The method of claim 10, wherein selecting the corresponding portion of the amount to be allocated to each respective savings goal comprises:
determining an ideal allocation amount for each savings goal;
determining a prioritized allocation amount for each ideal allocation amount based on a priority of the respective savings goal;
determining a savings goal score for each respective savings goal based at least in part on the prioritized allocation amount and a time elapsed from a most recent assignment of savings to the respective savings goal; and
selecting the corresponding portion of the amount to be allocated to each respective savings goal based at least in part on the savings goal scores for each respective savings goal normalized by the amount to be allocated.

12. The method of claim 1, further comprising, in response to completing a savings goal, updating training data for the machine learning model based at least in part on the attributes of the first user.

13. The method of claim 1, further comprising:
determining that an unallocated amount in the single banking account is less than a new expense;
breaking one or more savings goals by proportionately reallocating savings away from the one or more savings goals based at least in part on a difference between the new expense and the unallocated amount in the single banking account.

14. The method of claim 13, further comprising updating training data for the classification model based at least in part on the broken one or more savings goals.

15. A system for recommending and automating savings goals within a single banking account, the system associated with a machine learning model and comprising:
one or more processors; and
a memory storing instructions that, when executed by the one or more processors, cause the system to perform operations comprising:
training the machine learning model based at least in part on historical user data;
receiving attributes of a first user;
generating, using the trained machine learning model, one or more recommended savings goals for the first user based at least in part on the attributes of the first user;
receiving selection of one or more of the recommended savings goals;
determining, using a trained classification model, a recommended amount for the first user to periodically save, the recommended amount determined based at least in part on the attributes of the first user; and
periodically allocating savings to each of the one or more selected savings goals based at least in part on the recommended amount.

16. The system of claim 15, wherein the historical user data maps historical user transaction categories and historical user attributes to corresponding previously selected savings goals of historical users.

17. The system of claim 15, wherein the trained classification model maps savings amounts and attributes of users' to corresponding savings goal failure indicators, the savings goal failure indicators indicating whether or not a corresponding savings goal is predicted to be unsuccessful; and
wherein the recommended amount is a highest savings amount predicted by the trained classification model to result in a successful savings goal.

18. The system of claim 15, wherein execution of the instructions for periodically allocating savings to each of the one or more selected savings goals causes the system to perform operations further comprising, once per specified time period:
selecting an amount to be allocated among the one or more selected savings goals;
selecting a corresponding portion of the amount to be allocated to each respective savings goal of the one or more selected savings goals; and
assigning the corresponding portion to each respective savings goal of the one or more selected savings goals.

19. The system of claim 18, wherein execution of the instructions for selecting the corresponding portion of the amount to be allocated to each respective savings goal comprises:
determining an ideal allocation amount for each savings goal;
determining a prioritized allocation amount for each ideal allocation amount based on a priority of the respective savings goal;
determining a savings goal score for each respective savings goal based at least in part on the prioritized allocation amount and a time elapsed from a most recent assignment of savings to the respective savings goal; and
selecting the corresponding portion of the amount to be allocated to each respective savings goal based at least in part on the savings goal scores for each respective savings goal normalized by the amount to be allocated.

20. A system for recommending and automating savings goals within a single banking account, the system coupled to a machine learning model and comprising:
one or more processors; and
a memory storing instructions that, when executed by the one or more processors, cause the system to perform operations comprising:
training the machine learning model based at least in part on historical user data;
receiving attributes of a first user;
generating, using the trained machine learning model, one or more recommended savings goals for the first user based at least in part on the attributes of the first user;
receiving selection of one or more of the recommended savings goals;
determining, using a trained classification model and based at least in part on the attributes of the first user, a recommended amount for the first user to periodically save, wherein the recommended amount is a highest savings amount predicted by the trained classification model to result in a successful savings goal; and
periodically allocating savings to each of the one or more selected savings goals based at least in part on the recommended amount.
